(19) United States
(12) Patent Application Publication
(10) Pub. No.: US 2005/0060250 A1
(43) Pub. Date: Mar. 17, 2005

(54) Billing and ordering system and method for services provided over communications networks

(75) Inventors: Amit Heller, Belmont, CA (US); Ziv Haparnas, Tel Aviv (IL)

Correspondence Address: F. JASON FAR-HADIAN, Esq.;CENTURY IP LAW GROUP, Suite 1815, 222 Figueroa St., Los Angeles, CA, 90012-2601, US

(73) Assignee: Mobile (R&D) Ltd.

(21) Appl. No.: 10/664,390

(22) Filed: Sep. 17, 2003

(51) Int. Cl. G06F 17/60

(52) U.S. Cl. 705/34

(57) ABSTRACT

A method for ordering a service over a communications network is provided. The method comprises selecting a first service to be provided from a first system to a second system. The service is associated with a first code. A message comprising the first code and user identifying information is generated in response to selecting the first service. The message is forwarded to the first system from the second system.

### BACKGROUND

1. Field of the Invention

The present invention relates generally to electronic billing services and, more particularly, to a system and method for automatically ordering and billing for services provided over a communications network.

### COPYRIGHT & TRADEMARK NOTICES

A portion of the disclosure of this patent document contains material, which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is for providing an enabling disclosure by way of example and shall not be construed to limit the scope of this invention to material associated with such marks.

2. Related Art

Mobile communication technology and communication related services continue to grow at a rapid pace. One of the most popular services provided over various mobile communication networks is the short message service (also referred to as SMS). This service allows a user of a mobile communication device, such as a cellular telephone, to communicate with another party by way of transmitting an electronic text message. The text is typically created as a result of the user interaction with the mobile communication device's keypad.

Certain mobile communication service providers, in addition to messaging and communication services, provide a variety of other services. Some of these services, for example, provide a user with the option of downloading software code that can be executed on a mobile communication device. The software can provide additional functionality, operation or enhanced features for the mobile device. For example, a user can select to download a particular image, game, tune, icon or other accessory to enhance, upgrade, customize or personalize the operation of the device or its features. Instead of downloading software code, a user may decide to subscribe to a service. For example, a user may subscribe to a service that allows the user to purchase storage space to store photos in a photo album on a server.

Typically, a cost is associated with downloading the software code or subscribing to a service. That is, a user is charged for the service or downloaded feature by a service or content provider. Usually, the charge is added to the user's service bill (e.g., telephone bill) by a first party service provider. Sometimes, the mentioned services or features are provided by third party providers that have an affiliation with the first party service provider. As such, a complicated system needs to be in place to adequately track the financial relationships, transactions and billings among the multiple parties.

Currently, a user may use the SMS to submit an order for downloading and purchasing a feature. To do this, the user must have knowledge of a particular ordering method, which requires familiarity with an ordering syntax and an identifying code for the particular feature being ordered. The ordering syntax may be a keyword (e.g., a download command) that indicates that the user is submitting a download order. The identifying code (e.g., SPD-ICN-001) identifies the exact feature (e.g., a Spiderman icon) the user intends to download. The identifying code can be found in special publications or obtained from Internet portals. Based on the command and the identifying code, the service provider causes the corresponding software code to be downloaded to the user's device. The user is then billed accordingly.

Several disadvantages are associated with the current system and method. For example, the requirement for knowing and learning a particular command or ordering syntax and feature code is inconvenient for the user. Further, the chances for erroneously keying in a command or feature code make the ordering process cumbersome and add to user frustration. These inconveniences can also discourage the user from frequent use of the service.

Thus, improved and user-friendly ordering and billing methods and systems are needed that can overcome the above shortcomings. Resolution of the above problems will also lead to increased revenues for the service providers and their affiliates.

### SUMMARY

The present disclosure is directed to a system and corresponding methods that facilitate automatic ordering and billing for services provided via a communications network. The system provides a user with a user interface in which the user can select from a menu of features. In response to user selection, a SMS message is automatically generated in correspondence with the selected feature and is transmitted to the appropriate service provider or billing system. This obviates the need for the user to learn or memorize any ordering syntax, keywords, or terminologies. Also, the user need not memorize or know any identifying codes to order the service or feature.

For purposes of summarizing, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein.

In accordance with one aspect of the invention, a method for ordering a service over a communications network is provided. The method comprises selecting a first service to be provided from a first system to a second system, the service associated with a first code, the first and second systems connected to the communications network; and automatically generating a message comprising the first code and user identifying information in response to said selection, wherein the message is forwarded to the first system from the second system. The first service is then provided from the first system to the second system.

In one or more embodiments, the first system is a communication service provider. The second system is a wireless mobile communication device. The first feature is software code for enhancing functionality of the second system. The first code identifies the service to be provided from the first system. And, the user identifying information provides the first system with information needed for billing a user selecting the first feature

In one embodiment, the message is automatically generated by way of short message service (SMS) technology. The message may further comprise a command to download a first feature. Sometimes, a third system in communication with at least the second system causes the second system to generate the message. The third system can be a third party portal providing one or more features for download.

In accordance with other embodiments, the first system comprises a billing system and a database comprising user account information. The second system comprises application software in communication with server software executed on the third system, wherein the application software in response to one or more commands submitted by the server software generates the message forwarded to the first system.

In yet another embodiment of the invention, an electronic system for ordering a service over a communications network is provided. The system comprises means for selecting a first service from a plurality of services provided by a service provider, the first service associated with a first code; and means for automatically generating a message comprising the first code and user identifying information, wherein the message is forwarded to the service provider. The service is provided to a mobile communication device connected to the service provider via a wireless communications network.

The message can be a short text message and further comprise a download command in combination with the first code, wherein the first code identifies a feature to be downloaded from the service provider to the mobile communication device. A third device can act as an interface between the mobile communication device and the service provider, in accordance with one embodiment.

In accordance with another embodiment, a computer readable medium comprising logic code configured for processing by a microcontroller is provided. Execution of the logic code causes a computing system to establish a connection with a service provider; select a first service from a plurality of services available on the service provider, the first service being associated with a first code; construct a short text message comprising the first code and user identifying information, in response to said selection; and forward the short text message to the service provider, wherein the service provider uses the first code and the user identifying information for providing the first service to the user and for billing the user for the provided service.

These and other embodiments of the present invention will also become readily apparent to those skilled in the art from the following detailed description of the embodiments having reference to the attached figures, the invention not being limited to any particular embodiments disclosed.

### BRIEF DESCRIPTION OF THE DRAWINGS

Embodiments of the present invention are understood by referring to the figures in the attached drawings, as provided below.

FIG. 1 illustrates an exemplary communications environment in accordance with one or more embodiments of the invention;

FIG. 2 is a flow diagram of a billing method for services provided over a communications network, in accordance with one or more embodiments; and

FIGS. 3A and 3B are block diagrams of hardware and software environments in which a system of the present invention may operate, in accordance with one or more embodiments.

Features, elements, and aspects of the invention that are referenced by the same numerals in different figures represent the same, equivalent, or similar features, elements, or aspects, in accordance with one or more embodiments.

### DETAILED DESCRIPTION

An electronic system and corresponding methods, according to an embodiment of the present invention, facilitate and provide an automatic ordering and billing system for services provided over a communications network.

The terms electronic services, services, and online services are used interchangeably herein. The services provided by the system of this invention, in one or more embodiments, are provided by a service provider. A service provider is an entity that operates and maintains the computing systems and environment, such as server systems and infrastructure that enable the delivery of information and services. Typically, server architecture comprises of components (e.g., hardware, software, and communication lines) that store and offer electronic or online services.

In the following, numerous specific details are set forth to provide a thorough description of various embodiments of the invention. Certain embodiments of the invention may be practiced without these specific details or with some variations in detail. In some instances, features not pertinent to the novelty of the system are described in less detail so as not to obscure other aspects of the invention.

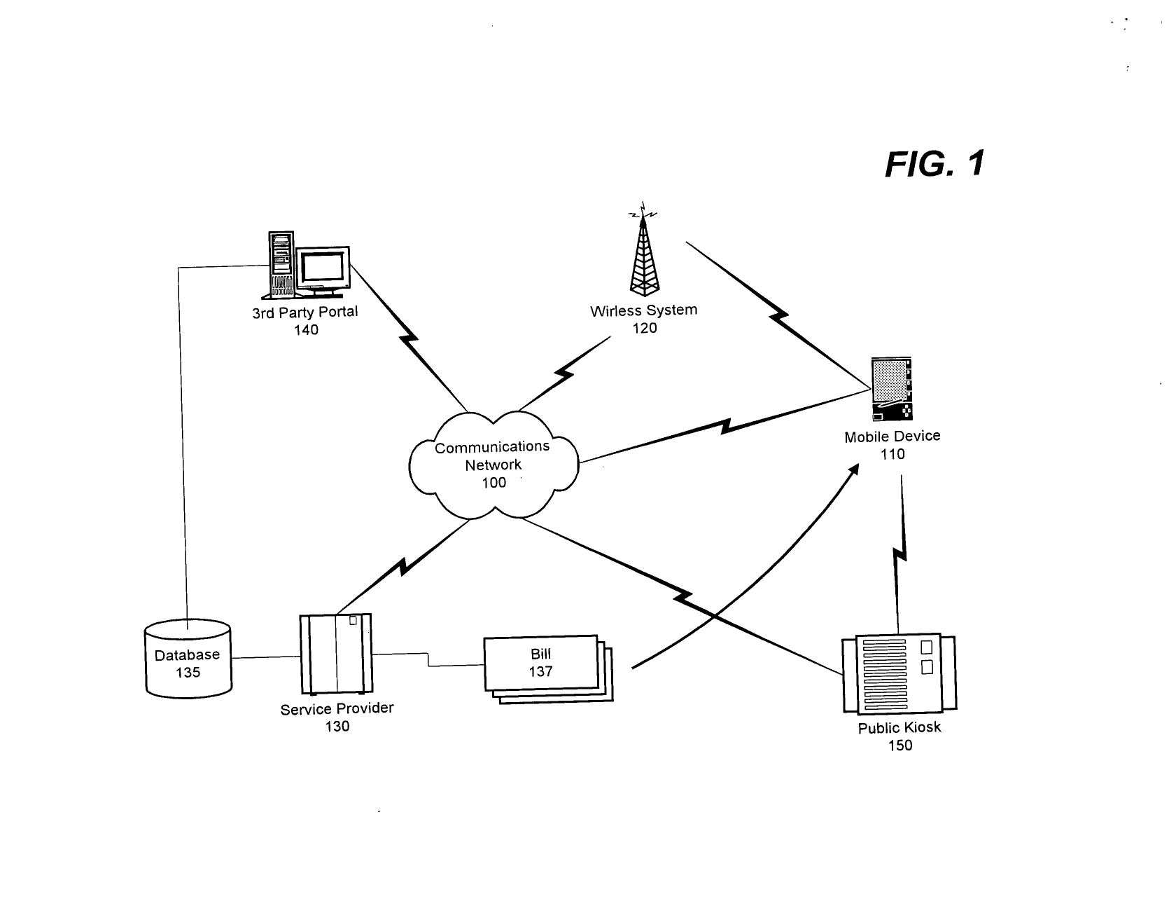

Referring to the drawings, FIG. 1 illustrates an exemplary communications environment in which the system of the present invention may operate. In accordance with one aspect of the system, the environment comprises a mobile device 110 and a service provider 130, each connected to a communications network 100. The terms “connected,” “coupled,” or any variant thereof, mean any connection or coupling, either direct or indirect, between two or more elements. The coupling or connection between the elements can be physical, logical, or a combination thereof.

In one embodiment, service provider 130 communicates with the mobile device 110 via communications network 100. The communications network 100 provides the medium for transmitting digital or analog signals between service provider 130 and mobile device 110. In certain embodiments, mobile device 110 is a cellular telephone and communications network 100 is a telephone network, for example. Mobile device 110, service provider 130 and communications network 100, however, may be implemented over any type of mobile, fixed, wired or wireless communication system.

As shown, mobile device 110 may communicate directly or indirectly with service provider 130 via a wireless system 120 or communications network 100, or both. In some embodiments, communications network 100 can be a wired or wireless local area network, a wide area network, or part of the world wide web (i.e., the Internet). The Internet connects millions of computers world wide through standard common addressing systems and communications protocols (e.g., Transmission Control Protocol/Internet Protocol (TCP/IP), HyperText Transport Protocol), creating a vast communications network.

In either context, mobile device 110 can communicate with service provider 130 to send and receive electronic packets of information, in form of electronic requests and responses. In a particular embodiment, the packets are constructed based on a text messaging service called short message service (SMS). SMS enables short messages (e.g., between 140-160 characters in length, for example) to be transmitted from a mobile device, such as a cell phone. SMS is supported in the GSM technology and other digital-based mobile communications systems. Similar to e-mail, short messages are stored and forwarded at SMS centers. Advantageously, SMS messages and requests are transmitted over control channels and do not exert any additional load on the system's voice channels.

Accordingly, in one embodiment, service provider 130 processes requests submitted by one or more mobile devices 110 and services the requests. In certain embodiments, service provider 130 is an email or SMS server that forwards email or text messages to a network address (e.g., IP address) specified in the request. Service provider 130, however, can provide any type of electronic service, in accordance with other aspects of the system. For example, in addition to text messaging services, imaging, voice, streaming audio/video, and other communication services may be supported and delivered to mobile device 110, by service provider 130.

In one embodiment, service provider 130 is a wireless communications service provider (e.g., Sprint, AT&T and Verizon) to which a user may subscribe. Depending on implementation, the user can access service provider 130 to request a service or download various data or software code to a mobile device 110. The downloaded data or code can be used to enhance or add to features and functionality of mobile device 110. For example, a user can download an image, screen saver, tune, ring, game, or other useful and entertaining features, accessories or updates. Alternatively, a user may subscribe to a service, such as an electronic photo album or other network based services that provide access to content and features.

For each service or downloaded feature, the user is charged a certain fee, in accordance with one aspect of the invention. The fees are included in a bill 137 generated by service provider 130 (or other billing entity). Bill 137 is forwarded to the user periodically (e.g., on a monthly basis). Typically, service provider 130 maintains a database 135 that comprises billing and account information for the user or subscriber. Such information comprises of, for example, user name, address, account id, service type, phone configuration and other pertinent account information. Account information is safely guarded by service provider 130, as the information contains private, valuable and sensitive consumer related data.

In one or more embodiments, service provider 130 is among one of plurality of sources a user can access to download additional features for mobile device 110. Accordingly, referring to FIG. 1, a mobile device 110 may submit requests to a third party portal 140 via communications network 100 and/or wireless system 120 to access additional services or features that may not be provided by service provider 130. Third party portal 140, in one embodiment, services the requests directly.

Alternatively, third party portal 140 may forward received user requests to service provider 130 or other server systems connected to communications network 100. That is, third party portal 140 can act as a conduit (i.e., interface) between mobile device 110 and one or more first party or third party service providers. Thus, third party portal 140 in some embodiments can perform some or all of the functions of service provider 130 or provide access to such services.

Given the confidential and valuable nature of consumer account information, in certain embodiments of the system, third party portal 140 does not have direct access to account information of the user who may want to order a particular feature or subscribe to a certain service. Accordingly, it is not possible for third party portal 140 to directly generate a bill 137 for the provided services. Thus, third party portal 140 communicates with service provide 130 to generate the respective bills 137, according to the services used or features downloaded by each user.

In certain embodiments, third party portal 140 may be given access to certain account information stored in data base 135, so that the information can be directly updated by third party portal 140. In a preferred embodiment, despite update access, third party portal is dependent on service provider 130 to generate bill 137. In other embodiments, third party portal 140 is given sufficient access to database 135 so that it can independently generate consumer statements and bill 137.

Some of the services provided by the system of the present invention may be accessed by application software installed and executed on mobile device 110, as provided in further detail below. The application software may, for example, act as a browser. A browser is a software program that allows the user to connect to a third party portal 140 or service provider 130 and access content provided thereon. In one embodiment, the browser is an embedded browser configured for execution on mobile device 10.

In other embodiments, the browser may be a standard browser such as the Microsoft Internet Explorer® or a WebTV, for example. Alternatively, other types of access software, such as, by way of example, custom network browsers, special communication software, cable modem software, point-to-point software, multi-point software, custom emulation software, embedded application software and the like, can be used.

In accordance with one embodiment, instead of or in addition to using a browser system executed on the mobile device 110, the user may use a general computer or other terminal (e.g., a public kiosk 150) that can communicate with the service provider 130 or third party portal 140 to place an order. According to this embodiment, after a user places the order, the general computer or public kiosk 150 communicate the details of the transaction to mobile device 110, for example, by way of a wireless interface (e.g., Bluetooth, WiFi, etc.).

Mobile device 110 then transmits a request (e.g., in form of a SMS message) including the transaction details to service provider 130 so that a bill 137 can be generated according to the type of feature or service ordered. The transaction details may comprise information about the location (i.e., the user's phone number) from which a user is placing the request, the destination address (i.e., the call center's phone number), a keyword or code identifying the service or feature request, etc. A bill can be generated based on one or more of these details.

One of ordinary skill in the art will appreciate that communications network 100 and wireless system 120 may advantageously be comprised of one or a combination of various types of networks without detracting from the scope of the invention. Such networks can, for example, comprise local area networks (LANs), wide area networks (WANs), public, private or secure networks, value-added networks, interactive television networks, wireless communications networks, two-way cable networks, satellite networks, interactive kiosk networks, cellular networks, personal mobile gateways (PMGs) and/or any other suitable communications network.

In certain embodiments, the application software executed on mobile device 110 can act as a client software that is in communication with a server software executed on service provider 130, third party portal 140 or another intermediate server, such as a gateway server. For example, in one embodiment, mobile device 110 may comprise a PMG device or communicate with a PMG device. The PMG architecture comprises a PMG server that can wirelessly communicate with a number of PMG enabled devices within the personal area of the user, thus providing a personal area network (PAN).

In addition, the PMG server can wirelessly communicate with remote server systems, such as a service provider 130, or third party portal 140 via wireless system 120 or communications network 100 in a WAN. Thus, the PMG acts as an interface to seamlessly connect a PAN to a WAN, and as such the devices attached to the PAN or WAN can communicate with each other. A more detailed description of the PMG architecture is provided in U.S. patent application No. ______, file on ______, the entire content of which is hereby incorporated by reference here.

As used herein, the terms mobile device, wireless system, third party portal, kiosk, service provider and communication networks are to be viewed as designations of one or more computing environments that comprise application, client or server software for servicing requests submitted by respective software included in devices or other computing systems connected thereto. These terms are not to be otherwise limiting in any manner. The application software, for example, may be comprised of one or more modules that execute on one or more computing systems, as provided in further detail below.

Application Software for Ordering and Billing Services

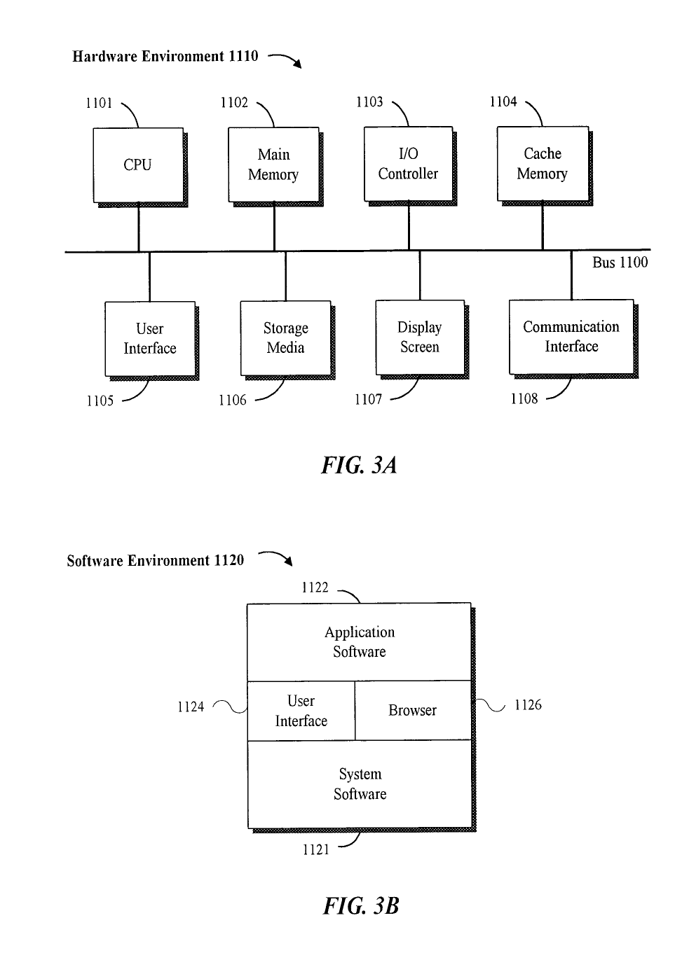

Referring to FIGS. 1 and 3A, in accordance with one aspect of the invention, application software 1122 is implemented on mobile device 110 to allow a user to browse certain services available from service provider 130 or third party portal 140 and order a feature or service by sending an SMS message. In other embodiments, the application software is capable of communicating with a third party device, such as a general computer, a kiosk 150, or a PMG device to place the order. The application software 1122, in some embodiments, may receive instructions from the third party device to generate and send a message (e.g., SMS message) to service provider 130 or a billing service, so that the service or feature are ordered and a bill 137 is generated.

It should be noted, however, that the exemplary embodiments disclosed above are not to be construed to limit the scope of the invention to application software that is exclusively executed on mobile device 110, or a system that exclusively operates based on SMS to generate a request. In some embodiments, application software 1122 may be implemented on a device or system other than mobile device 110. For example, application software 1122 or its components may be implemented, installed, and executed either in a singular or in a distributed environment. Certain components of the application software 1122 may be installed and executed on mobile device 110, while other components may be executed and installed on third party portal 140, service provider 130, or other systems attached thereto such as a PMG device. Other messaging services or communication protocols may be utilized to generate a request for service.

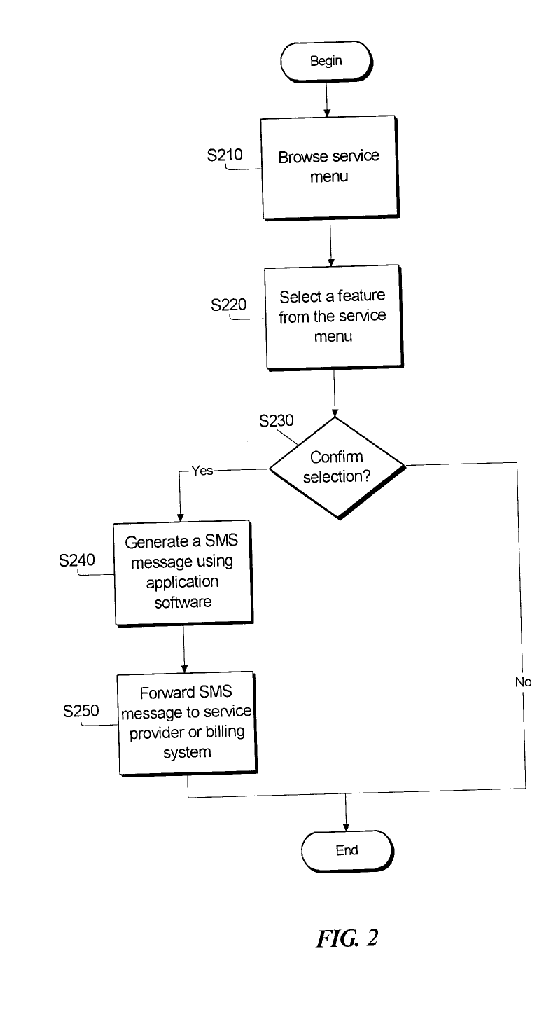

Referring to FIGS. 1 and 2, in accordance with one aspect of the invention, mobile device 110 initiates communication with at least one of service provider 130 or third party portal 140, depending on implementation. For example, if a service or feature is not directly provided by service provider 130, a connection is established with third party portal 140. The communication can be initiated either automatically or by the user. For example, the user can dial a code or program mobile device 110 to establish the connection. If the connection is not successful, mobile device 110 tries again to establish a connection.

Referring to FIG. 2, if the communication is successfully established, then mobile device 110 browses a service menu (S210). The service menu, for example, can be comprised of a list of various contents, features or services that can be ordered by the user. Such content may comprise streaming audio or video (e.g., music, movies, animated features, etc.), images (e.g., still pictures, icons, wallpaper, etc.), electronic documents (e.g., e-books, e-magazines, e-newspapers, etc.), interactive media (e.g., html, XML documents, games, etc.) or equivalents thereof

Browsing through the menu, the user can interact with mobile device 110's user interface (e.g., keypad) to select a service or feature from the menu (S220). For example, a user may select a graphic representation of Spiderman® on mobile device 110's screen to download the game Spiderman®. Or the user may select a text entitled “American Pie” to download a movie or song associated with that title. Certain embodiments of the system prompt the user to confirm the selection (S230). If the user fails to confirm, then system will abort the process. Otherwise, the system generates a request (e.g., SMS message), using the application software (S240).

A request, in accordance with one embodiment of the system, comprises identifying information associated with mobile device 110 and information about the ordered feature. For example, the identifying information may comprise the electronic serial number (ESN) of mobile device 110 or the telephone number registered to mobile device 110. The ESN and the telephone number uniquely identify the mobile device so that the ordered feature can be made available and billed to the user. Similarly, the ordered feature is identified based on a unique code. The unique code can be a combination of alphanumeric characters. Unique code identifies the ordered feature, based on which the cost of the order can be calculated.

In certain embodiments, the cost of the order may be calculated simply based on the identifying information for the service provider 130 or third party 140 (i.e., the number called by the user to submit the order), and thus a unique code may not be included. In some embodiments, the identifying information for mobile device 110 may not be included in the request, if service provider 130 or third party 140 has already received this information during the call embellishment process. In addition to the identifying information, the request can comprise a command. For example, in an SMS message the command may be “DWNLD. The command is followed by a feature code, in one or more embodiments.

The communication signals transmitted by mobile device 110 may also comprise additional identifying information to identify one or more user accounts established on one or more servers, such as service provider 130 and third party portal 140. For example, a user may have an account on the service provider 130, and also a separate account on third party portal 140. Either way, application software 1122 after generating the request, preferably in form of an SMS message, forwards the request to the appropriate service provider 130 or third party portal 140 (S250). Based on the information submitted in the request, service provider 130 or third party portal 140 transmit the requested feature to mobile device 110 via communications network 100.

In certain embodiments, mobile device 110 may not be configured to directly communicate with service provider 130. Thus, a user instead of using mobile device 110 uses a third device (e.g., a kiosk 150) that is capable of communicating directly with service provider 130 to place the order. Once the order is placed, the third device communicates certain transaction details (e.g., feature code) to mobile device 110. Application software 1122 executed on mobile 110 then processes the transaction details and sends a message (e.g., SMS message), comprising the transaction details and a unique user identifier (e.g., ESN of mobile device 110) to service provider 130. Based on the information contained in the message service provider 130 can both provide the service and also bill the user. Mobile device 110 and the third device may communicate over a PAN via a wireless communication interface (e.g., Bluetooth or WiFi).

In certain embodiments of the system, at least one of service provider 130 or third party portal 140 or both are connected to a database 135. Database 135, as discussed earlier, is used to store subscription and activity records related to the user and services provided to the user. The records are accessible for a variety of purposes, such as authentication, billing, and forwarding correspondence, as the records contain user contact and financial information. Identifying information, received in a submitted request, is incorporated into database 135 records to update the user activities and also for billing purposes.

One or more bills 137 are generated for the services or features ordered by a user. In certain embodiments, the information in the request submitted by mobile device 110 is used to calculate the charges that appear on a user's statement. Bills 137 may be generated by service provider 130 or third party portal 140, depending on system implementation or agreements between various vendors and providers. Alternatively, a separate billing system may be used to generate bills 137 and forward them to the user.

In embodiments of the system, mobile device 110, wireless system 120, kiosk 150, third party server 140 and service provider 130 comprise a controlled computing system environment that can be presented largely in terms of hardware components and software code executed to perform processes that achieve the results contemplated by the system of the present invention. A more detailed description of such system environment is provided below with reference to FIGS. 3A and 3B.

As shown, a computing system environment is composed of two environments, a hardware environment 1110 and a software environment 1120. The hardware environment 1110 comprises the machinery and equipment that provide an execution environment for the software. The software provides the execution instructions for the hardware. It should be noted that certain hardware and software components may be interchangeably implemented in either form, in accordance with different embodiments of the invention.

Software environment 1120 is divided into two major classes comprising system software 1121 and application software 1122. System software 1121 comprises control programs, such as the operating system (OS) and information management systems that instruct the hardware how to function and process information. Application software 1122 is a program that performs a specific task.

In certain embodiments of the invention, system and application software are implemented and executed on one or more hardware environments to select a first feature for download from a service provider 130 to a mobile device 110, wherein the feature is associated with a first code. The application software then automatically generates a message comprising the first code and user identifying information in response to said selection, and forwards the message to service provider 130.

Referring to FIG. 3A, an embodiment of the application software 1122 can be implemented as computer software in the form of computer readable code executed on a general purpose hardware environment 1110 that comprises a central processor unit (CPU) 1101, a main memory 1102, an input/output controller 1103, optional cache memory 1104, a user interface 1105 (e.g., keypad, pointing device, etc.), storage media 1106 (e.g., hard drive, memory, etc.), a display screen 1107, a communication interface 1108 (e.g., a network card, a blue tooth port, a modem, or an integrated services digital network (ISDN) card, etc.), and a system synchronizer (e.g., a clock, not shown in FIG. 3A).

Cache memory 1104 is utilized for storing frequently accessed information. A communication mechanism, such as a bi-directional data bus 1100, can be utilized to provide for means of communication between system components. Hardware Environment 1110 is capable of communicating with local or remotes systems connected to a communications network (e.g., a PAN or a WAN) through communication interface 1108.

In one or more embodiments, hardware environment 1110 may not include all the above components, or may include additional components for additional functionality or utility. For example, hardware environment 1110 can be a laptop computer or other portable computing device that can send messages and receive data through communication interface 1108. Hardware environment 1110 may also be embodied in an embedded system such as a set-top box, a personal data assistant (PDA), a wireless communication unit (e.g., cellular phone), or other similar hardware platforms that have information processing and/or data storage and communication capabilities. For example, in one or more embodiments of the system, hardware environment 1110 may comprise a PMG unit or an equivalent thereof

In embodiments of the system, communication interface 1108 can send and receive electrical, electromagnetic, or optical signals that carry digital data streams representing various types of information including program code. If communication is established via a communications network, hardware environment 1110 may transmit program code through the network connection. The program code can be executed by central processor unit 1101 or stored in storage media 1106 or other non-volatile storage for later execution.

Program code may be transmitted via a carrier wave or may be embodied in any other form of computer program product. A computer program 10 product comprises a medium configured to store or transport computer readable code or a medium in which computer readable code may be embedded. Some examples of computer program products are memory cards, CD-ROM disks, ROM cards, floppy disks, magnetic tapes, computer hard drives, and network server systems.

In one or more embodiments of the invention, processor 1101 is a microprocessor manufactured by Motorola, Intel, or Sun Microsystems Corporations, for example. The named processors are for the purpose of example only. Any other suitable microprocessor, microcontroller, or microcomputer may be utilized.

Referring to FIG. 3B, software environment 1120 is stored in storage media 1106 and is loaded into memory 1102 prior to execution. Software environment 1120 comprises system software 1121 and application software 1122. Depending on system implementation, certain aspects of software environment 1120 can be loaded on one or more hardware environments 1110.

System software 1121 comprises control software, such as an operating system that controls the low-level operations of hardware environment 1110. Low-level operations comprise the management of the system resources such as memory allocation, file swapping, and other core computing tasks. In one or more embodiments of the invention, the operating system can be Nucleus, Microsoft Windows CE, Microsoft Windows NT, Macintosh OS, or IBM OS/2. However, any other suitable operating system may be utilized.

Application software 1122 can comprise one or more computer programs that are executed on top of system software 1121 after being loaded from storage media 1106 into memory 1102. In a client-server architecture, application software 1122 may comprise client software and server software. Referring to FIG. 1 for example, in one embodiment of the invention, client software is executed on mobile unit 110 and server software is executed on service provider 130, third party portal 140 and kiosk 150.

Software environment 1120 may also comprise web browser software 1126 for accessing content on a remote server. Further, software environment 1120 may comprise user interface software 1124 (e.g., a Graphical User Interface (GUI)) for receiving user commands and data. The received commands and data are processed by the software applications that run on the hardware environment 1110. The hardware and software architectures and environments described above are for purposes of example only. Embodiments of the invention may be implemented in any type of system architecture or processing environment.

Embodiments of the invention are described by way of example as applicable to systems and corresponding methods that facilitate ordering of services provided over a communications network. In this exemplary embodiment, logic code for performing these methods is implemented in the form of, for example, application software 1122. The logic code, in one embodiment, may be comprised of one or more modules that execute on one or more processors in a distributed or non-distributed communication model.

It should also be understood that the programs, modules, processes, methods, and the like, described herein are but exemplary implementations and are not related, or limited, to any particular computer, apparatus, or computer programming language. Rather, various types of general-purpose computing machines or customized devices may be used with logic code implemented in accordance with the teachings provided, herein. Further, the order in which the methods of the present invention are performed is purely illustrative in nature. These methods can be performed in any order or in parallel, unless indicated otherwise in the present disclosure.

The methods of the present invention may be performed in either hardware, software, or any combination thereof. In particular, some methods may be carried out by software, firmware, or macrocode operating on a computer or computers of any type. Furthermore, such software may be transmitted in the form of a computer signal embodied in a carrier wave, and through communication networks by way of Internet portals or websites, for example. Accordingly, the present invention is not limited to any particular platform, unless specifically stated otherwise in the present disclosure.

The present invention has been described above with reference to preferred embodiments. However, those skilled in the art will recognize that changes and modifications may be made in these preferred embodiments without departing from the scope of the present invention. Other system architectures, platforms, and implementations that can support various aspects of the invention may be utilized without departing from the essential characteristics as described herein. These and various other adaptations and combinations of features of the embodiments disclosed are within the scope of the invention. The invention is defined by the claims and their full scope of equivalents.

1. A method for ordering a service provided over a communications network, the method comprising:
selecting a first service to be provided by a first system to a second system, the service associated with a first code;
automatically generating a message comprising the first code, in response to said selection; and
forwarding the message to the first system from the second system,
wherein a third system in communication with at least the second system causes the second system to generate the message.

2. The method of claim 1 further comprising providing the first service from the first system to the second system.

3. The method of claim 1, wherein the first system is a communication service provider.

4. The method of claim 1, wherein the second system is a wireless mobile communication device.

5. The method of claim 1, wherein the first service is downloadable software code for enhancing functionality of the second system.

6. The method of claim 1, wherein the first code identifies the first service to be provided from the first system to the second system.

7. The method of claim 1, wherein the message further comprises user identifying information that provides the first system with information needed for billing a user.

8. The method of claim 1, wherein the message is automatically generated by way of short message service (SMS) in accordance with instructions from the third system.

9. The method of claim 1, wherein the message further comprises a command to provide the first service.

10. The method of claim 1, wherein the third system is a public kiosk providing one or more services.

11. The method of claim 1, wherein the third system is a third party portal providing one or more services.

12. The method of claim 1, wherein the first system comprises a billing system.

13. The method of claim 1, wherein the first system comprises a database comprising user account information.

14. The method of claim 1, wherein the second system comprises application software in communication with server software executed on the third system, wherein the application software in response to communication from the server software generates the message forwarded to the first system.

15. An electronic system for ordering a service provided over a communications network, the system comprising:
means for selecting a first service from a plurality of services provided by a service provider, the first service associated with a first code; and
means for automatically generating a message comprising the first code, wherein the message is forwarded to the service provider.

16. The system of claim 15, wherein the service is provided to a mobile communication device connected to the service provider via a wireless communications network.

17. The system of claim 16, wherein the message comprises text.

18. The system of claim 16, wherein the first code identifies a feature to be downloaded from the service provider to the mobile communication device.

19. The system of claim 16, wherein a third device acts as an interface between the mobile communication device and the service provider.

20. A computer readable medium comprising logic code, wherein execution of the logic code by a processor causes a mobile device to:
establish a connection with a service provider;
select a first service from a plurality of services provided by the service provider, the first service being associated with a first code;
construct a text message comprising the first code, in response to said selection; and
forward the text message to the service provider,
wherein the service provider uses the first code for providing the first service to the mobile device.
